(19) United States
(12) Patent Application Publication
(10) Pub. No.: US 2023/0368116 A1
(43) Pub. Date: Nov. 16, 2023

(54) FOLDING METHOD EVALUATION DEVICE, FOLDING METHOD EVALUATION METHOD, AND RECORDING MEDIUM

(71) Applicant: NEC Corporation, Tokyo (JP)

(72) Inventor: Katsuya SHIMIZU, Tokyo (JP)

(73) Assignee: NEC Corporation, Tokyo (JP)

(21) Appl. No.: 18/122,365

(22) Filed: Mar. 16, 2023

(30) Foreign Application Priority Data
May 11, 2022 (JP) 2022-077837

(51) Int. Cl. G06Q 10/0639

(52) U.S. Cl. CPC G06Q 10/06398

(57) ABSTRACT

A folding method evaluation device according to the present disclosure includes: one or more memories storing instructions; and one or more processors configured to execute the instructions to: detect a motion of folding a piece of clothing by a user based on sensor information; determine correctness of the motion of folding the piece of clothing based on a determination criterion associated to the pieces of clothing; and output a determination result to an output device.

This application is based upon and claims the benefit of priority from Japanese Patent Application No. 2022-077837, filed on May 11, 2022, the disclosure of which is incorporated herein in its entirety by reference.

### TECHNICAL FIELD

The present disclosure relates to a technology for giving an instruction of a clothing folding method or the like.

### BACKGROUND ART

JP 2004-101372 A discloses a work support device that outputs a work process associated to a work content input by a worker to the worker in such a way that the worker can check the work process by using a text or a video.

In the invention of JP 2004-101372 A, it is not necessary for a worker who is a learner to learn the work content from a skilled worker.

When an unskilled worker learns a clothing folding method by a text or a moving image, the motion is not viewed from some angles, which makes the unskilled worker difficult to understand the method. In addition, the unskilled worker is difficult to understand whether the way he/she folds is correct.

### SUMMARY

An object of the present disclosure is to provide a technology for assisting in learning a clothing folding method.

A folding method evaluation device according to one aspect of the present disclosure includes: one or more memories storing instructions; and one or more processors configured to execute the instructions to: detect a motion of folding a piece of clothing by a user based on sensor information; determine correctness of the motion of folding the piece of clothing based on a determination criterion associated to the pieces of clothing; and output a determination result to an output device.

A folding method evaluation method according to one aspect of the present disclosure executed by a computer includes: detecting a motion of folding a piece of clothing by a user based on sensor information; determining correctness of the motion of folding the piece of clothing based on a determination criterion associated to the pieces of clothing; and outputting a determination result to an output device.

A recording medium according to one aspect of the present disclosure records a folding method evaluation program for causing a computer to execute processing of detecting a motion of folding a piece of clothing by a user based on sensor information; processing of determining correctness of the motion of folding the piece of clothing based on a determination criterion associated to the pieces of clothing; and processing of outputting a determination result to an output device.

### BRIEF DESCRIPTION OF THE DRAWINGS

Exemplary features and advantages of the present invention will become apparent from the following detailed description when taken with the accompanying drawings in which:

FIG. 1 is a block diagram illustrating a configuration of a folding method evaluation device according to a first example embodiment;

FIG. 2 is an example of a determination result output screen according to the first example embodiment;

FIG. 3 is an example of a determination result output screen according to the first example embodiment;

FIG. 4 is an example of a database that outputs a determination result according to the first example embodiment;

FIG. 5 is an example of a determination result output screen according to the first example embodiment;

FIG. 6 is a flowchart illustrating an operation of the folding method evaluation device according to the first example embodiment;

FIG. 7 is a block diagram illustrating a configuration of a folding method evaluation system according to the first example embodiment;

FIG. 8 is a block diagram illustrating a configuration of a folding method evaluation device according to a second example embodiment;

FIG. 9 is a display example of a virtual space according to the second example embodiment;

FIG. 10 is a display example of the virtual space according to the second example embodiment;

FIG. 11 is a display example of the virtual space according to the second example embodiment;

FIG. 12 is a display example of the virtual space according to the second example embodiment;

FIG. 13 is a flowchart illustrating an operation of the folding method evaluation device according to the second example embodiment;

FIG. 14 is a block diagram illustrating a configuration of a folding method evaluation device according to a third example embodiment;

FIG. 15 is an example of a determination result output screen according to the third example embodiment;

FIG. 16 is a display example of a virtual space according to the third example embodiment;

FIG. 17 is a display example of the virtual space according to the third example embodiment;

FIG. 18 is a display example of the virtual space according to the third example embodiment;

FIG. 19 is a block diagram illustrating a configuration of a folding method evaluation device according to a fourth example embodiment;

FIG. 20 is a display example of a virtual space according to the fourth example embodiment;

FIG. 21 is a display example of the virtual space according to the fourth example embodiment;

FIG. 22 is a display example of the virtual space according to the fourth example embodiment; and

FIG. 23 is a diagram illustrating a hardware configuration in which the folding method evaluation device according to the present disclosure is implemented by a computer device and its peripheral devices.

### EXAMPLE EMBODIMENT

Hereinafter, example embodiments of the present invention will be described in detail with reference to the drawings. In the present disclosure, each folding method evaluation device is used for, for example, training of a folding method. Alternatively, the folding method evaluation device may be used in evaluation fields such as tests and contests other than training.

### First Example Embodiment

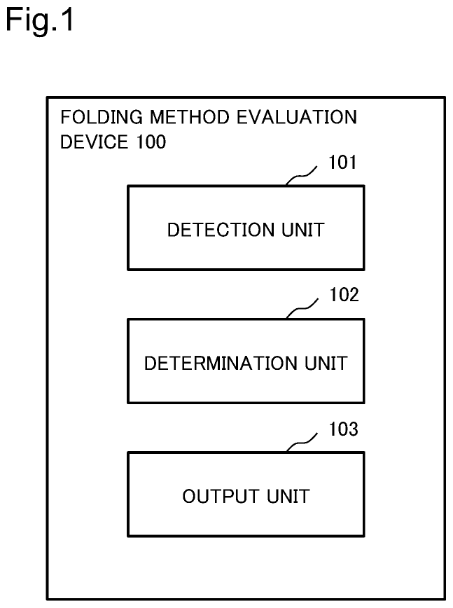

FIG. 1 is a block diagram illustrating a configuration of a folding method evaluation device 100 according to a first example embodiment. Referring to FIG. 1, the folding method evaluation device 100 includes a detection unit 101, a determination unit 102, and an output unit 103. The detection unit 101 detects a motion of folding a piece of clothing by a user based on sensor information. The determination unit 102 determines correctness of the detected motion based on a determination criterion associated to the piece of clothing. The output unit 103 outputs a determination result to an output device. The detection unit 101, the determination unit 102, and the output unit may be implemented by a combination of hardware such as a computer including a processor or a mobile communication terminal and firmware or software.

Next, a configuration of the folding method evaluation device 100 according to the first example embodiment will be described in detail.

In FIG. 1, the detection unit 101 is an example of detection means configured to detect a motion of folding a piece of clothing by the user based on the sensor information. The user is a person who uses the folding method evaluation device 100. The sensor information is, for example, an image obtained by imaging a motion of folding a piece of clothing by the user. In this case, the detection unit 101 acquires an image obtained by imaging a motion of folding a piece of clothing by the user from a camera communicably connected to the folding method evaluation device 100. The detection unit 101 analyzes the acquired image to detect the motion of folding the piece of clothing by the user. The detection unit 101 detects, for example, the positions and movements of the wrist joint and the finger joint of the person included in the image, thereby detecting the motion of the user. Alternatively, the detection unit 101 detects the motion of the user by detecting a state of the skeleton of the hand and the finger of the person included in the image. The detection unit 101 may detect movement of the body of the user including the hand, arm, and gaze.

The image is a real-time image captured by a camera that captures a motion of folding a piece of clothing. Alternatively, the image may be an image obtained by imaging a motion of folding a piece of clothing by the camera in advance. In this case, the image is stored in a memory (not illustrated).

In the present example embodiment, the motion of folding a piece of clothing by the user may be completed with one process for folding the piece of clothing or may be completed with a plurality of processes. Specifically, the detection unit 101 detects the motion of folding a piece of clothing for each process based on the above-described image which is the sensor information. That is, as described above, the detection unit detects the positions and movements of the wrist joint and the finger joint of the user included in the image, thereby detecting the motion of folding a piece of clothing by the user for each process. Alternatively, the detection unit 101 detects the state of the skeleton of the hand and the finger, thereby detecting the motion of folding a piece of clothing by the user for each process.

Next, an example of the detection will be described. In this example, the detection unit 101 detects a motion of folding a piece of clothing by using a trained model. For example, the detection unit 101 inputs an image obtained by imaging a motion of folding a piece of clothing to a trained model that is trained to identify the motion of folding a piece of clothing. Next, the detection unit 101 identifies the position and movement of each joint or a state of the skeleton of the hand and the finger as the motion from the input image by using the trained model. The detection unit 101 detects a motion feature representing the motion identified by the trained model in each process. Then, the detection unit 101 outputs the motion feature in each process of a clothing folding method to the determination unit 102 as a result of detection of the motion of folding a piece of clothing. The motion feature is a feature extracted from the motion. The detection of the motion of folding a piece of clothing by the detection unit 101 is not limited thereto, and may be performed by other methods.

The camera that images the motion of folding a piece of clothing by the user is, for example, a monitoring camera (not illustrated) provided in a store or a camera (not illustrated) provided in the folding method evaluation device 100. The camera that images the motion of folding a piece of clothing by the user may be implemented by a plurality of cameras. The detection unit 101 can eliminate a blind spot of the camera by using images captured by the plurality of cameras. For example, the sensor information is an image of each camera. In this case, the detection unit 101 detects the motion of the user from the images captured at the same time. For example, the sensor information may be an image obtained by combining the images of the cameras. In this case, the detection unit 101 detects the motion of the user from the composite image. The sensor information may be an image obtained by imaging the clothing folding method by the plurality of cameras from different directions. As a result, the detection unit 101 can more accurately detect the motion in each direction.

The determination unit 102 is an example of determination means configured to determine correctness of the detected motion of folding a piece of clothing based on the determination criterion associated to the piece of clothing. For example, the determination unit 102 may determine whether the motion of folding a piece of clothing is correct. For example, the determination unit 102 may determine whether a plurality of items are correct, and determine the total number of correct items or the number of incorrect items as the correctness.

For example, the determination unit 102 acquires the determination criterion associated to a piece of clothing from a storage unit (not illustrated). The storage unit (not illustrated) stores the determination criterion for each type of clothing as described later. The storage unit is communicably provided inside or outside the folding method evaluation device 100. Detection or estimation of a type of clothing for acquiring the determination criterion associated to the piece of clothing will be described later. Then, after the motion of folding a piece of clothing by the user detected by the detection unit and acquisition of the determination criterion associated to the piece of clothing, the determination unit 102 compares the motion and the determination criterion. The determination unit 102 determines the correctness of the motion of folding a piece of clothing by the user according to the comparison result. For example, the comparison result may be the degree of similarity between a feature representing the motion of folding a piece of clothing by the user and a feature that is the determination criterion associated to the piece of clothing. Alternatively, the comparison result may be a difference between information indicating the motion of folding a piece of clothing by the user and information indicating the determination criterion associated to the piece of clothing. In a case where the degree of similarity or the difference is larger than a threshold, the determination unit 102 determines that the motion of folding a piece of clothing by the user is incorrect, that is, the motion of folding a piece of clothing by the user is wrong. The operation of the determination unit 102 in which the correctness of the motion of folding a piece of clothing by the user is determined is not limited thereto.

The determination criterion associated to a piece of clothing is, for example, information in which the type of clothing and the determination criterion are associated with each other. The type of clothing may be a group classified by clothes that are folded differently. The type of clothing is classified according to, for example, a length of a sleeve, the presence or absence of a hood, the presence or absence of a collar, and the size. The type of clothing for which the folding method of the user is evaluated is determined by, for example, an operation input by the user or a manager of the user. In a case where the clothing folding method of the user is evaluated, first, the type of clothing may be input by an operation input by the user. The operation input is performed by, for example, an input device of a computer implementing the folding method evaluation device 100. The determination criterion is criterion information for comparison with the motion feature described above by the determination unit 102. In a case where the motion is represented by the motion feature, the criterion information is a motion feature serving as a reference. In the following description, the motion feature serving as the reference is referred to as a reference motion feature.

For example, the reference motion feature is generated as follows by using an image obtained by imaging a correct motion of a model worker who folds a piece of clothing. The reference motion feature is generated by the folding method evaluation device 100 or another information processing device. The generated reference motion feature is stored in the storage unit.

The positions and movements of the wrist joint and the finger joint of the model worker included in the image are detected for each process in order to generate the reference motion feature. Alternatively, the state of the skeleton of the hand and the finger of the model worker included in the image is detected for each process.

An example of the generation of the reference motion feature will be described. For example, an image obtained by imaging a motion of folding a piece of clothing by the model worker is input to the above-described trained model that has learned a motion of folding a piece of clothing. With the trained model to which the image of the model worker is input, the position and movement of each joint of the wrist and the finger, or the state of the skeleton of the hand and the finger of the model worker are identified as the motion. The identified motion feature representing the motion is detected for each process. Then, the motion feature in each process of the clothing folding method is output, that is, generated as the reference motion feature. The generation of the reference motion feature is not limited to this example.

The reference motion feature is generated for each type of clothing. Then, the reference motion feature is stored in the storage unit in association with a type of clothing for each type of clothing.

In order to acquire the determination criterion based on the type of clothing, the determination unit 102 may recognize the type of clothing from the image captured by the camera. For example, the determination unit 102 recognizes a piece of clothing included in the image captured by the camera by an image recognition technology using a trained model or the like. Then, the determination unit 102 specifies the type of clothing based on information associated with the recognized piece of clothing. For example, the determination unit 102 recognizes a shape of the piece of clothing included in the image captured by the camera. Then, the determination unit 102 may detect or estimate the type of clothing based on the recognized shape. In addition, a color of the piece of clothing may be used to detect or determine the type of clothing. Then, the determination unit 102 acquires the determination criterion associated to the type of clothing from a database. Thereafter, the determination unit 102 determines the correctness of the motion of folding a piece of clothing by the user based on the determination criterion associated to the type of clothing.

The determination unit 102 may determine the correctness of the motion for each of a plurality of processes based on the determination criterion set for each of the plurality of processes of the motion of folding a piece of clothing. The determination unit 102 may determine the correctness of the motion for each of the plurality of processes after the end of a series of motions of folding a piece of clothing. Alternatively, the determination unit 102 may determine the correctness of each motion for each of the plurality of processes every time each motion for each of the plurality of processes is completed. The series of motions of folding a piece of clothing is motions of folding one or more pieces of clothing.

The determination criterion handled by the determination unit 102 may be a list of evaluation items for evaluating a correct motion. The evaluation item is an item for determining correctness. The evaluation item is set for each motion. For example, the evaluation item is a correct point where the user holds a piece of clothing, and a point where a part of a hem, a sleeve, a shoulder, an armpit, or the like is to be present in the motion for each of the plurality of processes. It is sufficient if these points are represented by a positional relationship with respect to a part or the entire piece of clothing. A list including information of a plurality of evaluation items is stored as the determination criterion in the folding method evaluation device 100 or an external connectable storage unit.

As the determination criterion, information indicating a correct line along which a piece of clothing is to be folded, a time limit for the motion, or a correct order of the motion for each of the plurality of processes may be stored in the list of the evaluation items for a correct motion. In this case, the determination unit 102 determines whether the image matches the information indicating the evaluation item associated with each motion. For example, in a case where a correct point where the user holds a piece of clothing is set as the evaluation item, the determination unit 102 determines whether the positions of the hand of the user and the piece of clothing included in the image are correct points. For example, in a case where a time limit for the motion is set as the evaluation item, the determination unit 102 may determine whether a time taken for the motion is within the time limit. The determination unit 102 calculates the time taken for the motion from, for example, a time at which the motion detected from the image is started and a time at which the motion is ended. As the determination criterion, a range in which the motion is determined to be correct may be set.

The determination unit 102 may determine a state of a folded piece of clothing in addition to the motion of folding the piece of clothing by the user. In this case, the detection unit 101 further detects the state of the piece of clothing folded by the user from the image obtained by imaging the motion of folding the piece of clothing by the user. Then, the determination unit 102 may determine correctness of the state of the piece of clothing after each motion is performed for each of the plurality of processes. The determination criterion for the state of the piece of clothing folded by the user is, for example, a reference feature representing a position of a part of a hem, a sleeve, a shoulder, or an armpit of the piece of clothing folded by the model worker with respect to another part, or a horizontal width or vertical length of the folded piece of clothing.

The determination unit 102 may correct the determination of the motion of folding a piece of clothing by the user by determining the state of the piece of clothing folded by the user. For example, in a case where the motion of folding a piece of clothing is determined to be correct, but the state of the piece of clothing is determined to be incorrect, the determination unit 102 may correct the determination of the motion of folding a piece of clothing by the user and determine that the motion is incorrect.

The output unit 103 is an example of output means configured to output a determination result to the output device. The output unit 103 outputs the determination result of the determination unit 102 to the output device used by the user or a manager of the user. For example, the output device is a wearable display worn by the user or a display device that can be checked by the user. In this case, the output unit 103 causes the output device to display the determination result. Alternatively, the output device may be an audio output device. In this case, the output unit 103 may output the determination result to the audio output device. Alternatively, the output unit 103 may output the determination result not only to the output device but also to a database that records a result of evaluation on the folding method of the user.

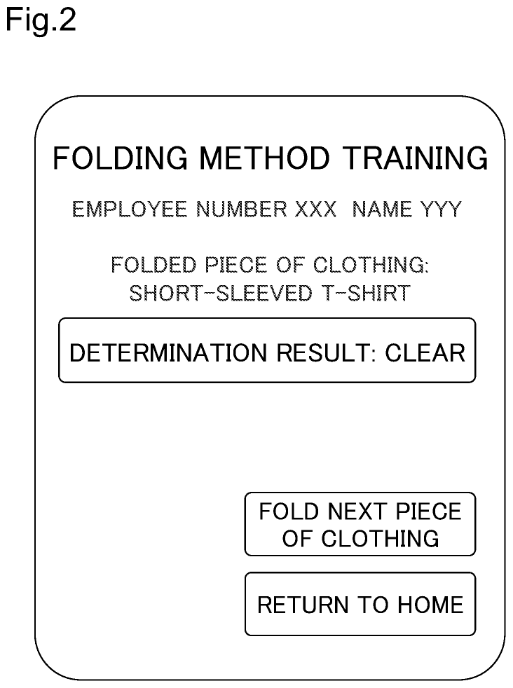

In a case where there is no mistake in the motion of folding a piece of clothing by the user, the output unit 103 outputs information indicating that the motion is correct to the output device as the determination result. FIG. 2 is an example of an output screen in a case where there is no mistake in the motion of folding a piece of clothing by the user. In the example of the output screen of FIG. 2, “determination result: CLEAR” is displayed. As illustrated in FIG. 2, the type of the folded piece of clothing (“folded piece of clothing: short-sleeved t-shirt” in FIG. 2) and user information (“employee number XXX name YYY” in FIG. 2) may be displayed on the output screen. Operation buttons such as “fold next piece of clothing” and “return to home” may be displayed on the output screen as illustrated in FIG. 2. The output of the determination result is not limited to this example.

In a case where there is a mistake in the motion of folding a piece of clothing by the user, the output unit 103 outputs information indicating that the motion is incorrect to the output device as the determination result. The determination result output from the output unit 103 to the output device for the user is at least one of correctness/incorrectness of the motion, correctness/incorrectness of each motion for each of the plurality of processes, an incorrect motion, or a correct motion related to the incorrect motion. For example, the output unit 103 may output a moving image of a correct motion related to an incorrect motion to the output device. The output unit 103 may output the determination result to the output device after a series of motions of folding a piece of clothing is completed. Alternatively, the output unit 103 may output the determination result for the motion for each of the plurality of processes to the output device.

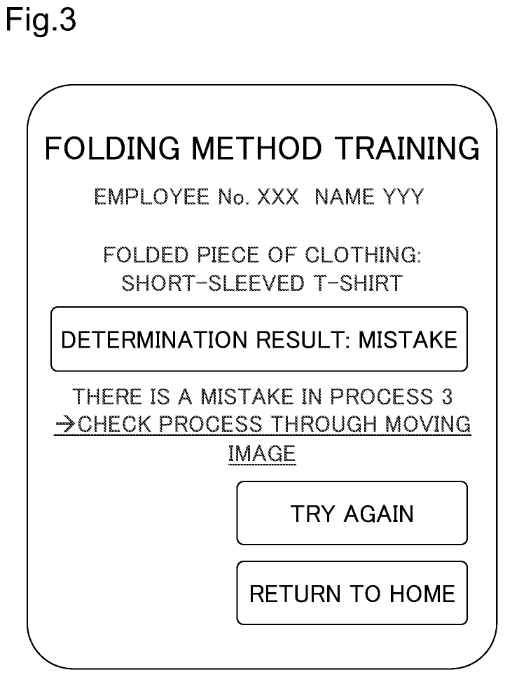

FIG. 3 is an example of an output screen in a case where there is a mistake in the motion of folding a piece of clothing by the user. In the example of the output screen of FIG. 3, “determination result: MISTAKE” is displayed. The output screen may display an incorrect motion like “there is a mistake in process 3” in FIG. 3. How the user has made a mistake in the incorrect motion may be displayed on the output screen like, for example, “the point to be held in process 3 is not the right sleeve but the right hem”. As illustrated in FIG. 3, an operation button for checking a correct process such as “check process through moving image” and an operation button for resuming evaluation such as “try again” may be displayed on the output screen. Also in a case where there is a mistake in the motion of folding a piece of clothing by the user, the output screen may display the type of the folded piece of clothing, information regarding the user, and an operation button for returning to an initial screen, as in FIG. 2. The output of the determination result is not limited to this example.

For example, the output unit 103 may output the determination result for the clothing folding motion of the user to a database that can be checked by the manager of the user. The database that can be checked by the manager of the user is, for example, a database that stores employee information. For example, the manager of the user is a person in a position of managing employees. As a result, in a case where the folding method training is performed for the user, the manager of the user can know the progress of the clothing folding method training of the user. The determination result output to the database that can be checked by the manager of the user is, for example, at least one of a determination result for each motion, a determination result for a series of motions, a final determination result for one day, the latest determination result, or the progress in the entire training. A training start date, the number of days elapsed from the training start date, and the total training time may be stored in the database in association with the determination result. The determination result in this case may be referred to as a training history.

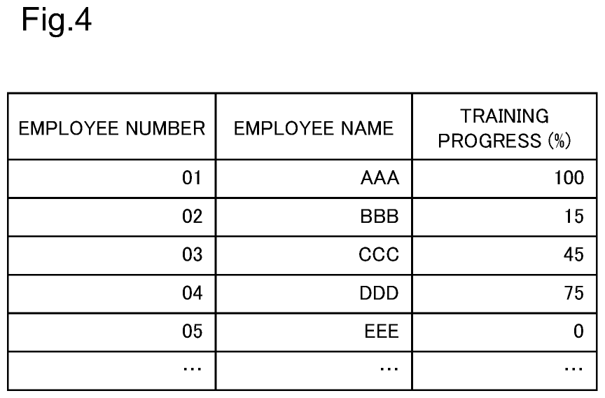

FIG. 4 is an example of the database that stores the determination result of the user who is an employee. In the example of the database of FIG. 4, an employee number and an employee name are stored as employee identification information. In the example of the database of FIG. 4, the progress of training for each employee is stored as the determination result. In this case, the output unit 103 calculates a progress rate of the user in the entire training. Then, the output unit 103 may output, to the database, an instruction to rewrite the progress rate associated with the identification information of the user into the calculated progress rate. The progress rate may be, for example, a value indicating, in percentage, the number of types of pieces of clothes for which it is determined that the motion of folding a piece of clothing is correct with respect to the total number of types of pieces of clothing in the training. The database that can be checked by the manager of the user is not limited to this example. The progress of the training is not limited to the above-described progress rate.

The output unit 103 may output the determination result for the clothing folding motion of the user to the database that can be checked by the manager of the user without outputting the determination result to the user. For example, in a case where the user uses the folding method evaluation device 100 for a training test of the folding method, the determination result may be reported only to the manager of the user.

The output unit 103 may output, to the output device, a determination result indicating that the motion of folding a piece of clothing has not been detected, or that the motion of folding a piece of clothing has been detected but determination of the motion of folding a piece of clothing has not been made. In this case, the output unit 103 may output, to the output device, information for giving an instruction to improve an image capturing environment for normally detecting or determining the motion of folding a piece of clothing. For example, the output unit 103 may output the position of the user with respect to the camera or the installation position of the camera to the output device.

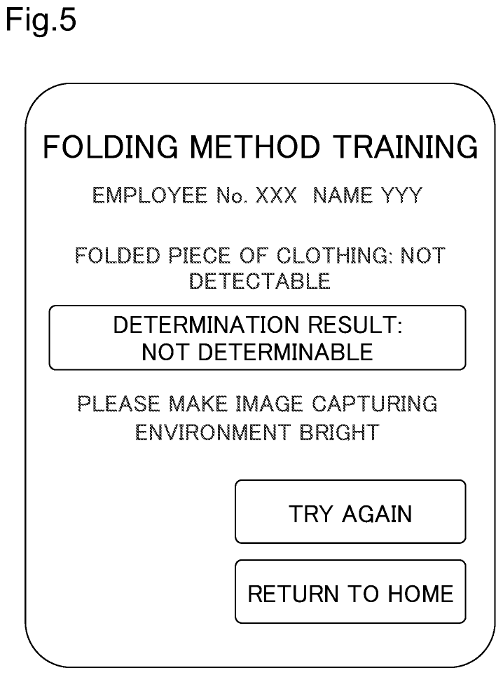

FIG. 5 is an example of an output screen in a case where the folding method evaluation device 100 has not been able to determine the motion of folding a piece of clothing by the user. In FIG. 5, the output screen displays that the folded piece of clothing is not detectable and that the motion of folding a piece of clothing is not determinable. The output screen may display an instruction to improve the image capturing environment, such as “please add more light in the image capturing environment” illustrated in FIG. 5. Also in a case where the motion of folding a piece of clothing is not detectable or determinable, the output screen may display the type of the folded piece of clothing, the information regarding the user, the operation button for evaluating the folding method for the same piece of clothing again, and an operation button for returning to the initial screen, as in FIG. 2.

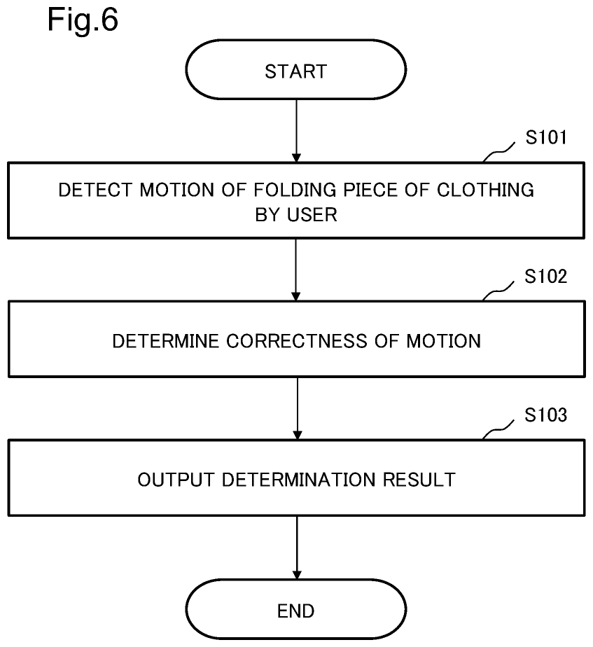

The operation of the folding method evaluation device 100 configured as described above will be described with reference to the flowchart of FIG. 6.

FIG. 6 is a flowchart illustrating an outline of the operation of the folding method evaluation device 100 according to the first example embodiment. The processing according to this flowchart may be executed based on program control by the processor.

As illustrated in FIG. 6, first, the detection unit 101 detects a motion of folding a piece of clothing by the user (step S101).

Next, the determination unit 102 determines whether the motion of folding a piece of clothing by the user detected in step S101 is correct based on a determination criterion associated to the piece of clothing (step S102).

Next, the output unit 103 outputs the determination result, which is a result of the determination in step S102, to the output device (step S103).

Then, the folding method evaluation device 100 ends a series of operations. Steps S101 to S103 may be performed for each motion divided into a plurality of processes. Each step and a combination of the steps may be repeated.

In the above-described folding method evaluation device according to the present example embodiment, the detection unit detects the motion of folding a piece of clothing by the user based on the sensor information. The determination unit determines correctness of the detected motion based on a determination criterion associated to the piece of clothing. The output unit outputs a determination result to an output device.

As a result, the folding method evaluation device according to the present exemplary embodiment can assist in learning a clothing folding method.

### Application Example of First Example Embodiment

As one application example of the first example embodiment, there is a folding method evaluation system 10 used in a store. In a store, a monitoring camera may be used to capture an image for detecting a motion. The monitoring camera is an example of the camera that captures an image for detecting a motion, and a camera other than the monitoring camera may be used.

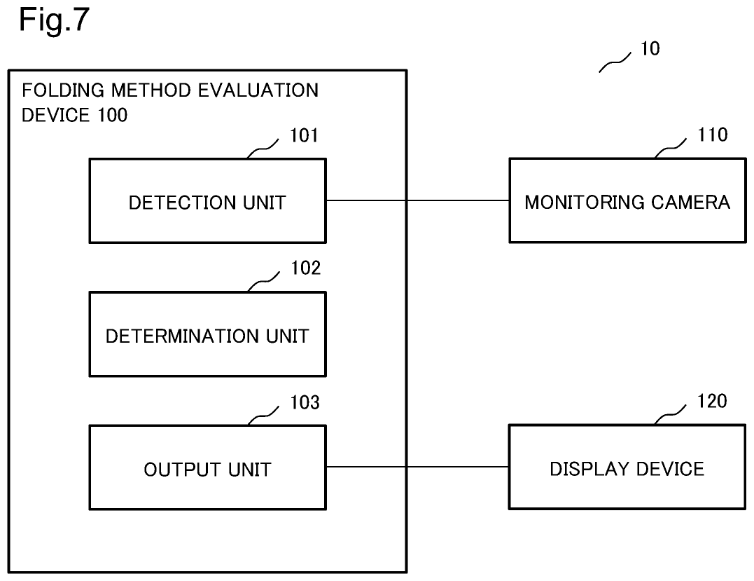

FIG. 7 is a block diagram illustrating a configuration of the folding method evaluation system 10 in a case where the folding method evaluation device 100 is used in a store. The folding method evaluation system 10 includes the folding method evaluation device 100, a monitoring camera 110 provided in the store, and a display device 120.

The folding method evaluation device 100 acquires, as the sensor information, an image of a motion of folding a piece of clothing by the user, the image being captured by the monitoring camera 110.

A trigger for the monitoring camera 110 to transmit the captured image of the motion of folding a piece of clothing to the folding method evaluation device 100 is, for example, that the monitoring camera 110 recognizes a specific motion of the user based on the image. In a case where the monitoring camera 110 recognizes the specific motion of the user, the monitoring camera 110 transmits the captured image of the motion of folding a piece of clothing to the folding method evaluation device 100.

Alternatively, the trigger for the monitoring camera 110 to transmit the captured image of the motion of folding a piece of clothing to the folding method evaluation device 100 may be communication with a terminal possessed by the user. In a case where wireless communication with a dedicated terminal for folding method evaluation possessed by the user becomes possible, the monitoring camera 110 transmits the captured image of the motion of folding a piece of clothing to the folding method evaluation device 100. Alternatively, when the user presses a button for an instruction to start folding method evaluation in the terminal possessed by the user, the monitoring camera 110 that has received a start instruction may transmit the captured image of the motion of folding a piece of clothing to the folding method evaluation device 100. A notification of the start instruction is transmitted to the monitoring camera 110 directly from the terminal possessed by the user or through the folding method evaluation device 100.

The display device 120 is an example of the output device that outputs the determination result. The display device 120 is, for example, a dedicated terminal for folding method evaluation possessed by the user, a terminal possessed by the user, or an eyeglass-type display device capable of displaying the determination result. In a case where the display device 120 is an eyeglass-type display device capable of displaying the determination result, the user wears the eyeglass-type display device capable of displaying the determination result to perform folding method evaluation. The eyeglass-type display device capable of displaying the determination result is a device capable of displaying information such as the determination result on eyeglasses that allow the user to visually recognize the surroundings. As described above, since the user wears a wearable terminal capable of outputting the determination result, the user does not need to carry the terminal to check the determination result. In particular, with the wearable display device 120 such as the eyeglass type, the user does not need to carry the terminal to visually check the determination result.

As another application example of the first example embodiment, the folding method evaluation device 100 may be implemented using a smart glass in which a camera is embedded.

### Second Example Embodiment

Next, a second example embodiment of the present disclosure will be described in detail with reference to the drawings. The second example embodiment is different from the first example embodiment in that the user performs a motion of folding a piece of virtual clothing displayed in a virtual space. Hereinafter, a description of contents overlapping with the above description will be omitted unless the description of the present example embodiment is unclear.

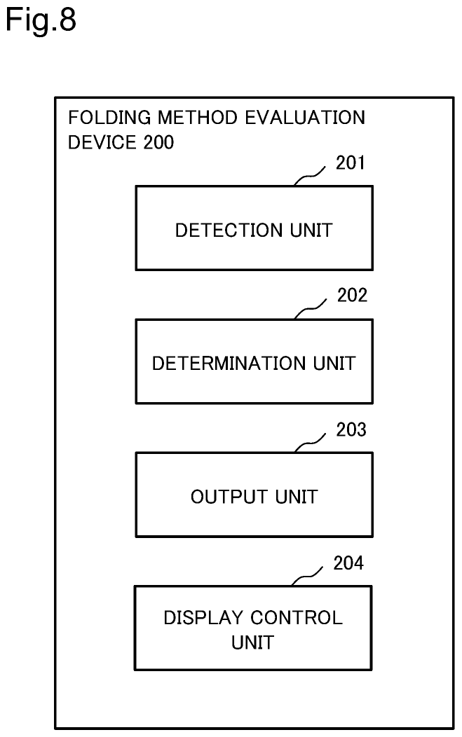

FIG. 8 is a block diagram illustrating a configuration of a folding method evaluation device 200 according to the second example embodiment of the present disclosure. The folding method evaluation device 200 of the second example embodiment includes a display control unit 204 in addition to the configuration of the first example embodiment. The folding method evaluation device 200 includes a detection unit 201, a determination unit 202, and an output unit 203 instead of the detection unit 101, the determination unit 102, and the output unit 103 of the first example embodiment.

First, the display control unit 204 is an example of display control means configured to display a piece of virtual clothing to be folded by the user in a virtual space. The display control unit 204 displays the virtual space on a display device that is, for example, a head-mounted display, a dome-type display, or an aerial display.

For example, the display control unit 204 causes the display device to display a piece of virtual clothing of a type selected by the user on a screen of the display device. Alternatively, the display control unit 204 may select the type of a piece of virtual clothing to be displayed. For example, the display control unit 204 selects the type of a piece of virtual clothing to be displayed based on a training history of the user. The display control unit 204 may select, from the training history, a piece of virtual clothing of a type for which the user has made a mistake in the motion to have a review. Alternatively, the display control unit 204 may select a type of a piece of virtual clothing for which the user has not been trained yet.

The display control unit 204 changes a state of a piece of virtual clothing to be displayed on the display device based on a motion of folding the piece of virtual clothing detected by the detection unit 201. For example, the display control unit 204 may search a database for a state of a piece of virtual clothing to be displayed next based on the state of the piece of virtual clothing displayed on the display device and the motion detected by the detection unit 201. For example, the display control unit 204 may calculate the state of the piece of virtual clothing to be displayed next from the state of the displayed piece of virtual clothing and the detected motion. In this case, for example, ease of movement, ease of stretching, ease of twisting, lightness, and the like of each position of the piece of virtual clothing are set. The display control unit 204 calculates a position of each point of a piece of virtual clothing to be output from an input motion.

In a case where the determination unit 202 determines that the motion of folding a piece of virtual clothing by the user is wrong, the display control unit 204 may return the displayed state of the piece of virtual clothing to the state before the incorrect motion is made.

The display control unit 204 may display a virtual hand of the user that folds a piece of clothing. The virtual hand is displayed in the virtual space and represents movement of the hand of the user. In this case, the display control unit 204 changes a state of the displayed virtual hand based on the motion detected by the detection unit 201. That is, the display control unit 204 changes the state of the displayed virtual hand in such a way that the virtual hand moves in conjunction with movement of the hand of the user. Alternatively, the display control unit 204 may display the actual hand of the user that folds a piece of virtual clothing and is cut out from the captured image. In this case, the displayed hand of the user may be, for example, an image of only a part of the hand captured by the camera provided in the display device, the image being displayed on the screen of the display device.

An example of the screen that the display control unit 204 causes the display device to display will be described. In the following description, at least one of the right hand or the left hand is the actual hand or the virtual hand described above.

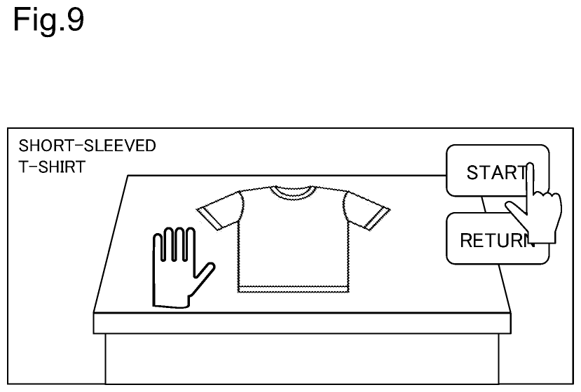

First, FIG. 9 is an example of the screen that the display control unit 204 causes the display device to display in the second example embodiment in a case where the user starts training for folding a piece of virtual clothing. A short-sleeved T-shirt, which is a piece of virtual clothing, is displayed at the center of FIG. 9. In an example of an initial screen of FIG. 9, the right hand and the left hand of the user are displayed. For example, in a case where the user moves the hand, an operation button “start” is selected in FIG. 9. The detection unit 201 may start detecting a motion with this operation as a trigger. A type of a piece of clothing displayed in a virtual space and for which a folding method of the user is to be evaluated may be displayed, like an indicator “short-sleeved T-shirt” in FIG. 9.

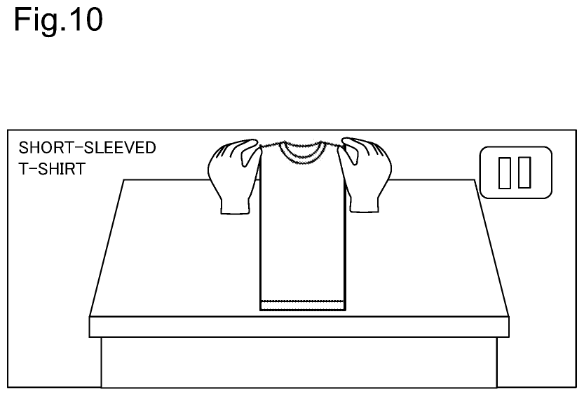

Next, FIG. 10 is an example of a screen that the display control unit 204 causes the display device to display in a case where the user makes the motion of folding a piece of virtual clothing in the second example embodiment. The example of the screen of FIG. 10 is an example of display after both shoulders of the short-sleeved T-shirt are held and further lifted by the left and right hands of the user after the initial screen of FIG. 9. As described above, the display of the left and right hands of the user and the piece of virtual clothing is changed based on the motion of folding a piece of clothing by the user detected by the detection unit 201. While the piece of clothing is folded as illustrated in FIG. 10, an operation button for the user to temporarily stop the training may be displayed as in the upper right of FIG. 10.

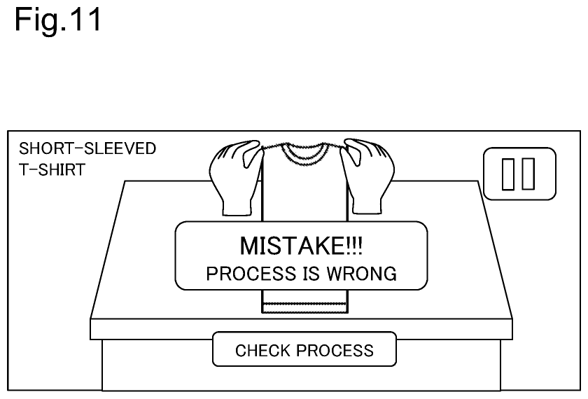

Next, FIG. 11 is an example of a screen that the display control unit 204 causes the display device to display in a case where the user makes a mistake in the motion of folding the piece of virtual clothing in the second example embodiment. In FIG. 11, in addition to the left and right hands of the user and the piece of virtual clothing, an indicator indicating that the user makes a mistake in the motion of folding the piece of virtual clothing is displayed. In a case where the user makes a mistake in the motion of folding the piece of virtual clothing, as illustrated in FIG. 11, information indicating how the motion is wrong, such as “process is wrong”, and an operation button for checking a correct process may be displayed.

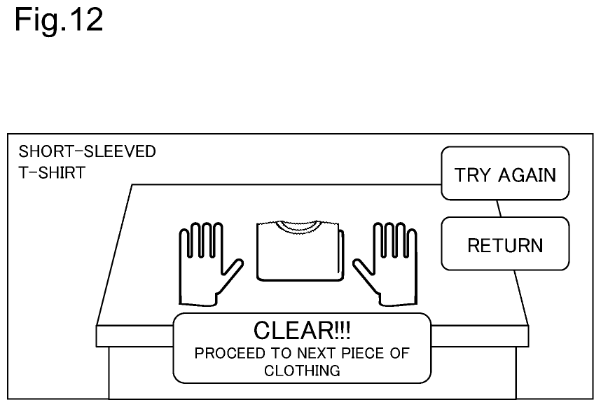

FIG. 12 is an example of a screen that the display control unit 204 causes the display device to display in a case where the user determines that the motion of folding the piece of virtual clothing is correct in the second example embodiment. In FIG. 12, in addition to the left and right hands of the user and the piece of virtual clothing, the display control unit 204 displays information indicating that it is determined that the motion of folding the piece of virtual clothing by the user is correct. In a case where it is determined that the motion of folding the piece of virtual clothing by the user is correct, an operation button for proceeding with training of the folding method, performing training of the method of folding the same piece of clothing again, returning to the initial screen, and the like may be displayed as illustrated in FIG. 12.

The detection unit 201 detects the motion of folding the piece of virtual clothing by the user displayed in the virtual space based on sensor information. The sensor information is, for example, information acquired by a motion sensor worn on the body of the user. For example, the motion sensor includes at least one of an acceleration sensor, a gyro sensor, or a geomagnetic sensor. The acceleration sensor is a sensor that measures an acceleration when there is a change in motion. The gyro sensor is a sensor that measures an angular velocity, which is a rotation speed. The geomagnetic sensor is a sensor that measures a direction of a geomagnetic vector. For example, the user wears the motion sensor on a point that moves in the motion of folding a piece of clothing, such as the arm, the hand, or the finger. For example, when the user wears gloves with the motion sensor and makes the motion of folding a piece of clothing, the detection unit 201 detects the clothing folding motion of the user based on information of the motion sensor.

The detection unit 201 may combine detection of the clothing folding motion of the user using the image and detection of the clothing folding motion of the user using the information of the motion sensor described in the first example embodiment. The detection of the clothing folding motion of the user using the information of the motion sensor may be applied to the detection unit 101 of the first example embodiment that detects a motion of folding a normal piece of clothing instead of a piece of virtual clothing.

The determination unit 202 determines correctness of the motion of folding the piece of virtual clothing by the user based on a determination criterion associated to the piece of virtual clothing detected by the detection unit 201. The determination criterion associated to the piece of virtual clothing may be associated with information of the piece of virtual clothing displayed by the display control unit 204. Alternatively, the determination unit 202 may acquire the determination criterion associated to information on a type of the piece of virtual clothing displayed by the display control unit 204 from a storage unit that stores a type of a piece of clothing and a determination criterion in association with each other.

The output unit 203 outputs the determination result to an output device. For example, the output unit 203 displays the determination result in the virtual space in which the piece of virtual clothing is folded. As in the first example embodiment, the output unit 203 may output the determination result to a database that can be checked by a manager of the user.

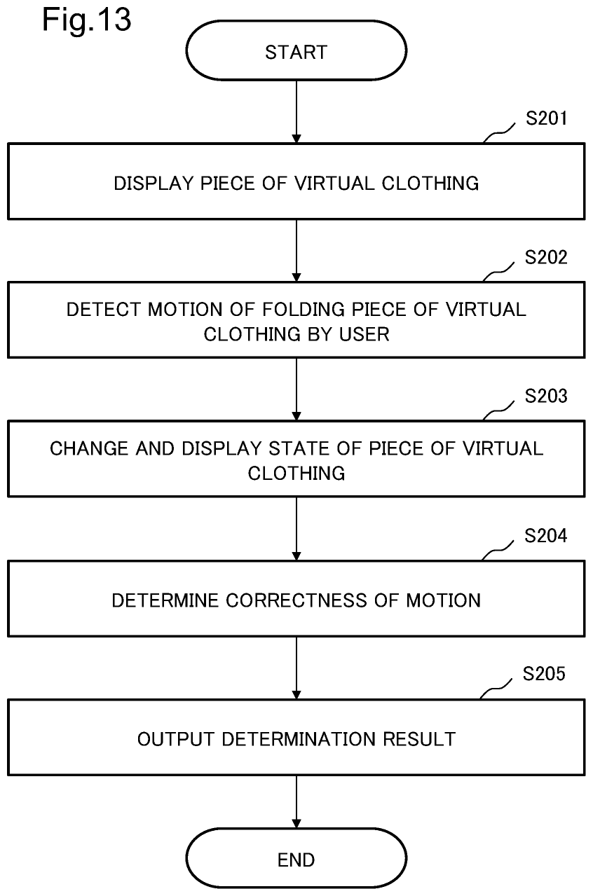

The operation of the folding method evaluation device 200 configured as described above will be described with reference to a flowchart of FIG. 13.

FIG. 13 is a flowchart illustrating an outline of the operation of the folding method evaluation device 200 according to the second example embodiment. The processing according to this flowchart may be executed based on program control by the processor.

As illustrated in FIG. 13, first, the display control unit 204 displays a piece of virtual clothing to be folded by the user (step S201).

Next, the detection unit 201 detects a motion of folding the piece of virtual clothing by the user (step S202).

Next, the display control unit 204 changes a state of the displayed piece of virtual clothing based on the motion of the user detected in step S202 (step S203).

Next, the determination unit 202 determines whether the motion of folding the piece of virtual clothing by the user is correct based on a determination criterion associated to the piece of virtual clothing (step S204).

Next, the output unit 203 outputs the determination result of step S204 to the output device (step S205).

Then, the folding method evaluation device 200 ends a series of operations. Steps S201 to S205 may be performed for each motion divided into a plurality of processes. Each step and a combination of the steps may be repeated.

In the above-described folding method evaluation device according to the present example embodiment, the display control unit displays a piece of virtual clothing. Then, the detection unit detects a motion of folding the piece of clothing by the user based on the sensor information. The determination unit determines correctness of the detected motion based on a determination criterion associated to the piece of clothing. The output unit outputs a determination result to an output device.

As a result, the folding method evaluation device according to the present exemplary embodiment can assist in learning a clothing folding method. In particular, the folding method evaluation device according to the present example embodiment can evaluate the clothing folding method without preparing a piece of clothing in the real space.

### Modified Example of Second Example Embodiment

In the second example embodiment, the user folds a piece of virtual clothing in a virtual space. However, in the second example embodiment, a piece of clothing in a real space may be used. The piece of clothing in the real space is a piece of clothing that can be held by the user in the real space rather than a virtual space.

In this case, the user performs training with the folding method evaluation device according to the second example embodiment by using the piece of clothing in the real space. For example, the display control unit 204 may display a piece of virtual clothing that is in conjunction with a motion of folding the piece of clothing in the real space based on a state of the piece of clothing in the real space captured by the camera. As a result, the display control unit 204 can change the state of the displayed piece of virtual clothing more accurately. The piece of clothing in the real space used in this case may include the motion sensor described in the second example embodiment. The display control unit 204 may change the state of the displayed piece of virtual clothing based on sensor information of the motion sensor provided in the piece of clothing in the real space.

The piece of clothing in the real space may be cloth other than clothes. The type of the piece of clothing in the real space and the type of the piece of virtual clothing displayed by the display control unit 204 may be different from each other. When the user uses clothes or cloth in the real space, the user can evaluate a method of folding various types of piece of virtual clothing without preparing various types of clothes. As a result, the clothing folding method of the user can be further naturally evaluated while having a feeling of folding the cloth.

### Third Example Embodiment

Next, a third example embodiment of the present disclosure will be described in detail with reference to the drawings. The third example embodiment is different from the first example embodiment and the second example embodiment in that a folding method evaluation device 300 detects and determines a bagging motion made by a user in addition to a folding motion made by the user. Hereinafter, a description of contents overlapping with the above description will be omitted unless the description of the present example embodiment is unclear.

In the present example embodiment, the bagging motion is a motion of putting clothes into a bag. For example, the bagging motion is a motion of putting purchased clothes into a shopping bag. Alternatively, the bagging motion may be a motion of putting clothes as a product into a shipping bag.

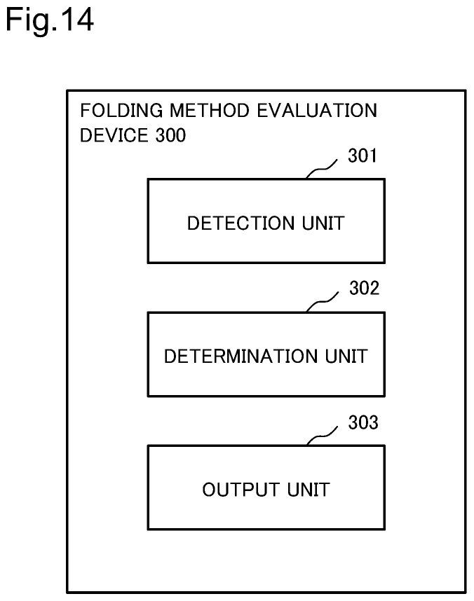

FIG. 14 is a block diagram illustrating a configuration of the folding method evaluation device 300 according to the third example embodiment of the present disclosure. The folding method evaluation device 300 according to the third example embodiment includes a detection unit 301, a determination unit 302, and an output unit 303. The folding method evaluation device 300 may include a display control unit 304 (not illustrated).

In addition to the function of the detection unit 101 or the detection unit 201, the detection unit 301 further has a function of detecting the bagging motion of the user. The detection of the bagging motion may be performed in the same manner as the detection of the clothing folding motion. The detection unit 301 may detect states of the bag and the clothes similarly to the detection of the state of a piece of clothing described above.

In addition to the function of the determination unit 102 or the determination unit 202, the determination unit 302 further has a function of determining correctness of the bagging motion of the user. The determination of the bagging motion may be performed similarly to the determination of the clothing folding motion. For example, the determination unit 302 determines the correctness of the bagging motion detected by the detection unit 101 or the detection unit 201 based on a determination criterion associated to the type of clothing and the number of pieces of clothing. The determination criterion associated to the type of clothing and the number of pieces of clothing is the type and number of bags appropriate for the type and number of pieces of clothing to be bagged. The appropriate type and number of bags are not limited to one or one combination. As in the first example embodiment, in a case where the user performs folding method training using a piece of clothing in a real space, the type of clothing and the number of pieces of clothing may be detected or estimated from an image obtained by imaging the motion of the user.

The determination unit 302 may determine correctness of selection of the bag by the user in the determination of the bagging motion. The correctness of the selection of the bag indicates whether the bag is an appropriate bag for putting clothes without being torn. For example, the selection of the bag is selection of a shopping bag for putting clothes. In this case, the clothes may be one or more pieces of clothing.

For example, the determination unit 302 may determine the correctness of the selection of the bag by the user based on appropriate bag information associated with the type of clothing. The appropriate bag information includes information indicating the type of the bag and the number of bags appropriate for the type of clothing. The type of the bag is the size of the bag. Alternatively, the type of the bag may include a material, a color, a pattern, and a shape of the bag. The type of clothing associated with the appropriate bag information may be a clothing combination. The clothing combination is the type of clothing and the number of pieces of clothing for each type of clothing. For example, in a case where pieces of clothing to be bagged are a combination of two short-sleeved T-shirts and one down jacket, the associated appropriate bag information may be a large paper bag.

Alternatively, the determination unit 302 may determine the correctness of the selection of the bag by the user based on the appropriate bag information determined for clothes to be bagged. A method for determining an appropriate bag for clothes is not limited.

The bag appropriate for clothes to be bagged may be determined by the determination unit 302 or an external information processing device. For example, the determination unit 302 or the external information processing device specifies the size of a piece of clothing to be bagged. The determination unit 302 or the external information processing device specifies, for example, the type and number of pieces of clothing. Next, the determination unit 302 or the external information processing device acquires size information stored in association with the specified type of clothing. Then, the determination unit 302 or the external information processing device calculates a total value of the sizes of all the clothes to be bagged.

Alternatively, the determination unit 302 or the external information processing device measures or estimates the size of a piece of clothing to be bagged. The measurement or estimation may be performed by a sensor or image recognition. Here, the size is at least one of a volume, a length, or a weight. The volume of a piece of clothing is preferably the volume after the piece of clothing is folded. Then, the determination unit 302 or the external information processing device determines the type and the number of bags according to the size of the specified type of clothing.

It is sufficient if the determination unit 302 or the external information processing device determines, as the appropriate bag, the type of bag in which the specified size of clothing within a range of sizes that can be put in the bag stored in association therewith for each type of bag can be put. It is sufficient if at least an upper limit is set as the range of sizes. The determination unit 302 or the external information processing device determines a plurality of appropriate types of bags and the number of bags for each type of bag in a case where the specified size of clothing exceeds the range of sizes that can be put in the bag. The determination unit 302 or the external information processing device may store a piece of bagging target clothing determined in this manner and the appropriate bag information in a database in association with each other.

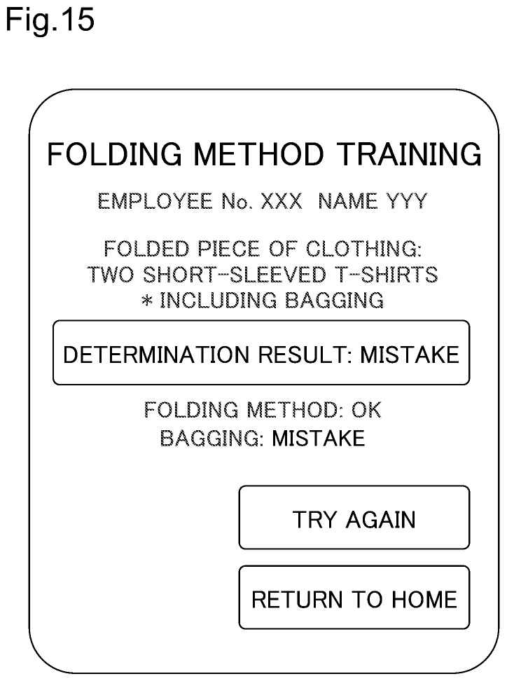

The output unit 303 outputs determination results for the motion of folding a piece of clothing and the bagging motion to the output device. The output content and the output destination are the same as those of the first example embodiment and the second example embodiment. FIG. 15 is an example of an output screen that the output unit 303 causes the output device to output. In FIG. 15, the output unit 303 outputs the determination result indicating that the motion is wrong to the output device. As illustrated in FIG. 15, the output unit 303 may output the determination result for the clothing folding motion and the determination result for the bagging motion to the output device. In a case where the selection of the bag is determined and the selection of the bag by the user is wrong, the output unit 303 may output, to the output device, a result indicating that the selection of the bag is wrong. As illustrated in FIG. 15, the output unit 303 may output, to the output device, the fact that the bagging motion has been detected and determined.

In a case where the folding method evaluation device 300 according to the third example embodiment is a device in which the user folds a piece of virtual clothing as in the second example embodiment, the folding method evaluation device 300 includes the display control unit 304 (not illustrated).

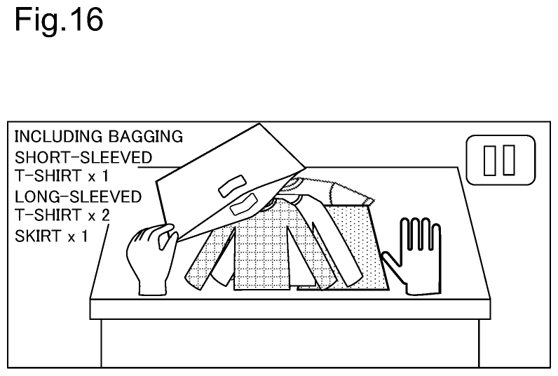

The display control unit 304 displays a virtual bag on a display device in addition to the piece of virtual clothing. FIG. 16 is an example of a screen that the display control unit 304 causes the display device to display. In FIG. 16, the display control unit 304 displays a piece of virtual clothing, a virtual hand of the user, and a virtual bag.

As in the second example embodiment, the display control unit 304 may display a virtual bag of a type selected by the user. Alternatively, the display control unit 304 may select the type of a piece of virtual clothing to be displayed. For example, the display control unit 304 may display an appropriate type and number of bags for the displayed piece of virtual clothing, that is, the piece of virtual clothing to be bagged.

The display control unit 304 may change a state of the displayed virtual bag based on a motion of the user on the virtual bag detected by the detection unit 301, similarly to the display control unit 204 of the second example embodiment. The state of the virtual bag is displayed in such a way that, for example, an opening of the virtual bag is opened when the user makes a motion of opening the bag.

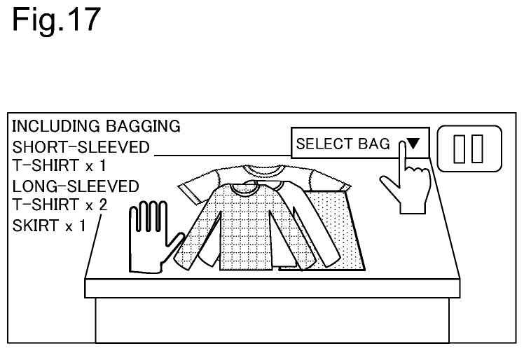

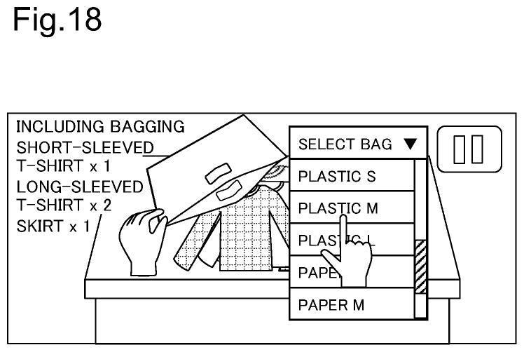

The display control unit 304 may display an option for the user to select a virtual bag. As a result, the folding method evaluation device 300 can detect and determine the selection of the bag made by the user in the virtual space. FIGS. 17 and 18 are display screen examples of bag options. In FIG. 17, in a case where the user makes a motion of selecting “select bag”, the display control unit 304 displays bag type options in FIG. 18. In the example of FIG. 18, the display control unit 304 displays bag materials and bag sizes as the options. The display example of the bag options is not limited thereto. For example, the display control unit 304 may display a virtual shelf and a plurality of types of virtual bags stocked on the virtual shelf as the bag options like an actual store. The display control unit 304 may display the options for the user to select a virtual bag after the user has finished folding a displayed piece of virtual clothing.

In the above-described folding method evaluation device according to the present example embodiment, the detection unit detects the motion of folding a piece of clothing and the bagging motion by the user based on the sensor information. The determination unit determines correctness of the detected motion based on a determination criterion associated to the piece of clothing. The output unit outputs a determination result to an output device.

As a result, the folding method evaluation device according to the present exemplary embodiment can assist in learning a clothing folding method. In particular, the folding method evaluation device according to the present example embodiment can support evaluation of a bagging method in addition to the clothing folding method.

### Fourth Example Embodiment

Next, a fourth example embodiment of the present disclosure will be described in detail with reference to the drawings. The fourth example embodiment is different from each of the above-described example embodiments in that a folding method evaluation device 400 determines a motion of folding a piece of clothing by a user according to a situation. Hereinafter, a description of contents overlapping with the above description will be omitted unless the description of the present example embodiment is unclear.

In the present example embodiment, the situation is a surrounding situation in which the user folds a piece of clothing.

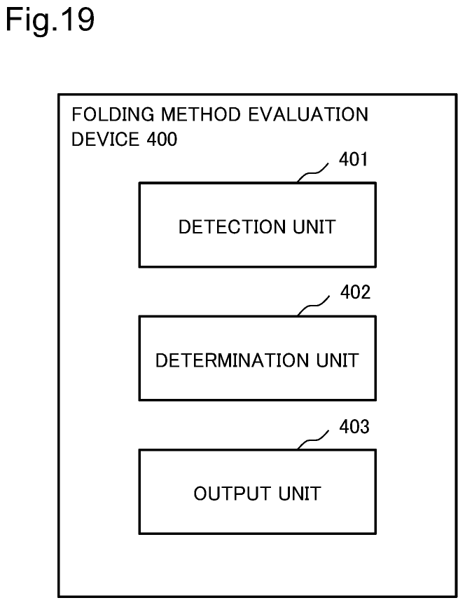

FIG. 19 is a block diagram illustrating a configuration of the folding method evaluation device 400 according to the fourth example embodiment of the present disclosure. The folding method evaluation device 400 according to the fourth example embodiment includes a detection unit 401, a determination unit 402, and an output unit 403. The folding method evaluation device 400 may include a display control unit 404 (not illustrated).

The determination unit 402 sets a determination criterion associated to a situation in which a piece of clothing is folded. That is, the determination unit 402 determines correctness of the motion based on a situation of folding a piece of clothing and the determination criterion associated to the type of clothing. The determination criterion associated to the situation may be set similarly to the first example embodiment.

In a case where the user folds a piece of clothing in a real space, for example, the determination unit 402 specifies a situation based on a surrounding image of the user. For example, the determination unit 402 recognizes a surrounding environment in which the user folds a piece of clothing from an image (hereinafter, referred to as a surrounding image) around a region where work of folding a piece of clothing is performed. The determination unit 402 specifies the recognized surrounding environment as the situation. Then, the determination unit 402 sets a determination criterion associated to the specified situation. Alternatively, in a case where the user folds a piece of virtual clothing, the determination unit 402 sets a determination criterion associated to the situation selected by the user or the display control unit 404.

The determination criterion may be set according to a situation in which the motion of folding a piece of clothing is different. For example, the situation is a situation in which there is a table or a situation in which there is no table that can be used by the user to fold a piece of clothing. That is, the motion of folding a piece of clothing by the user may be made by using the table in such a way as to fold a piece of clothing while placing the piece of clothing on the table or may be made without using the table. In this case, the determination unit 402 specifies whether the user uses the table when folding a piece of clothing. For example, the determination unit 402 specifies the presence or absence of a table around the user from the surrounding image captured by the camera. Then, in a case where there is a table around the user, the determination unit 402 specifies that the user uses the table when folding a piece of clothing. In a case where there is no table around the user, the determination unit 402 specifies that the user does not use the table when folding a piece of clothing. Then, the determination unit may set a determination criterion associated to the presence or absence of the specified table. For example, the determination unit 402 specifies the presence or absence of a table by using the above-described surrounding image of the user or a sensor that measures a distance to a peripheral object.

The determination criterion may be set according to a motion made in association with the motion of folding a piece of clothing. The determination criterion for each motion may be set in the same manner as in the first example embodiment. The determination unit 402 specifies each motion in the following situations detected by the detection unit 401. Then, the determination unit 402 determines correctness of the specified motion based on a determination criterion associated to the specified motion.

For example, the situation is a situation in which customer handling is performed with a cash register. In the situation in which customer handling is performed with a cash register, the detection unit 401 detects a motion for payment in addition to a clothing folding motion of the user. In the situation in which customer handling is performed with a cash register, the detection unit 401 may detect at least one of a bagging motion of the user and a conversation with a customer.

For example, in the motion for payment, the detection unit 401 detects a motion of receiving a product, a cash, a gift card, a card used for payment such as a credit card, or a point card by the user from a customer. In the motion for payment, the detection unit 401 detects a motion of passing a product, change, cards, a receipt, paper for campaign announcement, and the like to a customer. In the motion for payment, the detection unit 401 detects a motion of operating the cash register by the user. For example, the operation of the cash register is at least one of an operation of the cash register for various payment methods, a registration of a product in the cash register, a cancellation of the product, an addition of a point, and a subtraction of a point. The operation of the cash register is not limited thereto. The determination unit 402 determines correctness of each motion based on the determination criterion associated to the motion detected by the detection unit 401.

In a case where the detection unit 401 detects a conversation between the user and a customer, for example, the detection unit 401 further acquires a voice uttered by the user. Then, the detection unit 401 detects a word spoken by the user from a voice uttered by the user. The determination unit 402 determines correctness of the word in the utterance of the user detected by the detection unit 401 in a conversation with a customer based on the determination criterion. The determination criterion for the utterance of the user may be an utterance content of the user and wording uttered by the user. In the determination of each motion, the determination unit 402 may determine the correctness of the motion and the utterance.

Alternatively, the situation is a situation in which product shelves are arranged at a selling area of a store. In the situation in which product shelves are arranged in a selling area of a store, the user performs at least one of a motion of placing a piece of clothing on the product shelve or a motion of arranging pieces of clothing on the product shelves, in addition to the motion of folding a piece of clothing. In this situation, the user may make a motion of replacing the product shelf or a motion of changing a price label of a product.

Alternatively, the situation is a situation in which a piece of clothing is folded in a backyard of a store. In the situation in which a piece of clothing is folded in a backyard of a store, the user may make at least one of a motion of returning a piece of clothing, a motion of packing a piece of clothing in a box or a bag, or a mending motion such as shortening a hem, in addition to the motion of folding a piece of clothing.

As described above, the detection unit 401 may detect each motion of the user in a store and an utterance of the user toward a customer, in addition to the motion of folding a piece of clothing by the user.

The output unit 403 outputs the determination result to an output device, similarly to each of the above-described example embodiments.

In the folding method evaluation device 400 of the present example embodiment, in a case where the user folds a piece of virtual clothing, the folding method evaluation device 400 includes the display control unit 404.

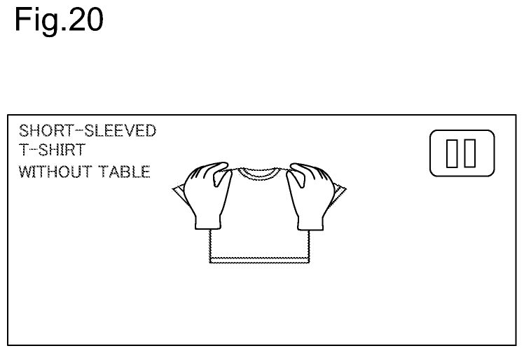

The display control unit 404 displays a virtual space according to each situation. For example, in a case of a situation in which there is a table, the display control unit 404 displays a virtual table as illustrated in FIGS. 9 and 10. In this case, the display control unit 404 displays the piece of virtual clothing in such a way that the piece of virtual clothing is placed on the virtual table. In a situation in which there is no table, the display control unit 404 does not display a virtual table as in the display example illustrated in FIG. 20.

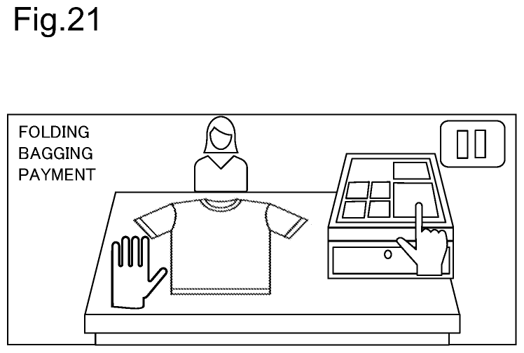

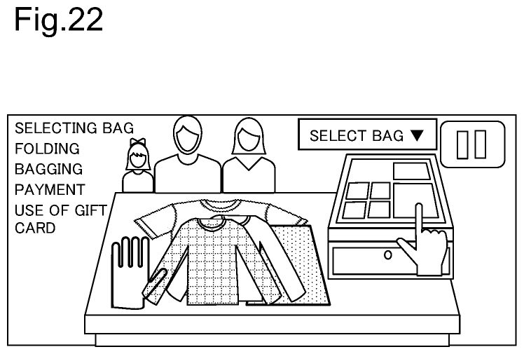

In the situation in which the user performs customer handling with a cash register, the display control unit 404 displays a virtual cash register and a counter stand, and a virtual customer. In this case, the display control unit may display a virtual basket and a virtual bag. FIG. 21 is a display example in which the display control unit 404 displays a piece of virtual clothing, a virtual cash register, a virtual counter stand, and a virtual customer. FIG. 22 is a display example in which the display control unit 404 displays bag options, a piece of virtual clothing, a virtual cash register, a virtual counter stand, and a virtual customer.

In a case where the display control unit 404 displays a virtual customer, the display control unit 404 may display an utterance content of the customer by text. The display control unit 404 may display options of utterance contents of the user for the customer. In this case, the determination unit 402 may determine correctness of an option of an utterance content selected by the user based on the determination criterion in which the options of the utterance contents and correct answer information are associated with each other. Alternatively, in a case where the display control unit 404 displays a virtual customer, an audio control unit (not illustrated) may output an utterance content of the customer by voice. The audio control unit causes an audio output device such as a speaker, an earphone, or a headphone through which the user can hear a voice to output the voice. For example, the audio control unit outputs a voice obtained by recording the utterance content of the customer at an output timing associated with the utterance content of the customer. Alternatively, the audio control unit may convert a text, which is the utterance content of the customer, into a voice reading out the text, thereby outputting the voice at the output timing associated with the utterance content of the customer.

In the above-described folding method evaluation device according to the present example embodiment, the detection unit detects the motion of folding a piece of clothing by the user based on the sensor information. The detection unit detects each motion associated to the situation. The determination unit determines correctness of the detected motion based on a determination criterion associated to the situation and the piece of clothing. The output unit outputs a determination result to an output device.

As a result, the folding method evaluation device according to the present exemplary embodiment can assist in learning a clothing folding method. In particular, the folding method evaluation device according to the present example embodiment can support evaluation of learning of various tasks in a store in addition to the clothing folding method.

### [Hardware Configuration]

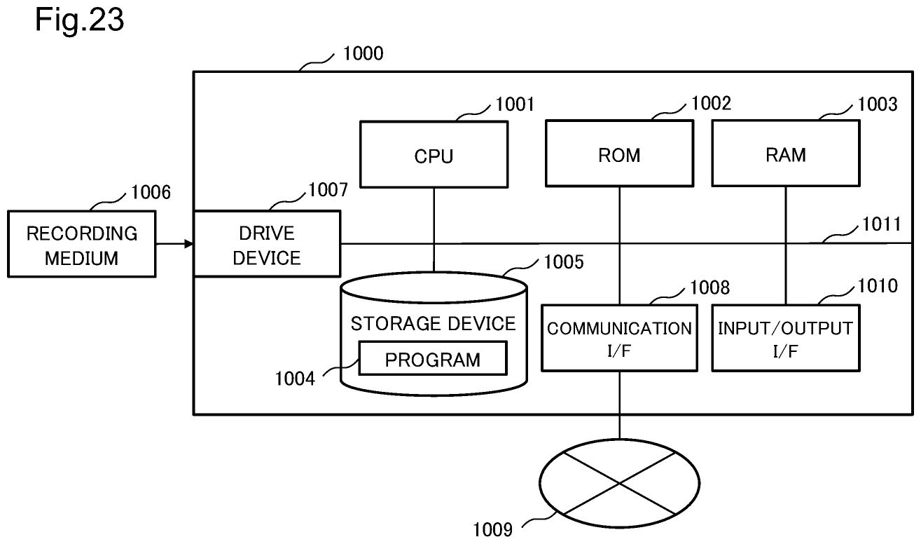

Some or all of the components of each device or system in each example embodiment of the present disclosure described above are implemented by, for example, any combination of an information processing device 1000 and a program as illustrated in FIG. 23. The information processing device 1000 has the following configuration by way of example.
A central processing unit (CPU) 1001
A read only memory (ROM) 1002
A random access memory (RAM) 1003
A program 1004 loaded to the RAM 1003
A storage device 1005 storing the program 1004
A drive device 1007 that performs reading and writing on a recording medium 1006
A communication interface (I/F) 1008 connected to a communication network 1009
An input/output interface (I/F) 1010 for inputting/outputting data
A bus 1011 connecting the components

Each component of each device or system in each example embodiment is implemented by the CPU 1001 acquiring and executing a program for implementing these functions. The program for implementing the function of each component of each device is stored in the storage device 1005 or the RAM 1003 in advance, for example, and the CPU 1001 reads the program as necessary. The program 1004 may be supplied to the CPU 1001 via the communication network, or may be stored in advance in the recording medium 1006, and the drive device 1007 may read the program and supply the program to the CPU 1001.

There are various modified examples of the method of implementing each device. For example, each device or system may be implemented by any combination of the information processing device 1000 and the program for each component. A plurality of components included in each device may be implemented by any combination of one information processing device 1000 and the program.

Some or all of the components of each device or system are implemented by a general-purpose or dedicated circuitry including a processor or the like, or a combination thereof. The circuitry is, for example, a CPU, a graphics processing unit (GPU), a field programmable gate array (FPGA), or a large scale integration (LSI). The LSI is, for example, an LSI dedicated to artificial intelligence (AI) processing. These may be implemented by a single chip or may be implemented by a plurality of chips connected via a bus. Some or all of the components of each device may be implemented by a combination of the above-described circuitry or the like and the program.

In a case where some or all of the components of each device or system are implemented by a plurality of information processing devices, circuitries, and the like, the plurality of information processing devices, circuitries, and the like may be arranged in a centralized manner or in a distributed manner. For example, the information processing device, the circuitry, and the like may be implemented as a form in which each is connected via a communication network, such as a client and server system or a cloud computing system.

An object of the present disclosure is to provide a technology for assisting in learning a clothing folding method.

An example of the effect of the present disclosure is that it is possible to assist in learning a clothing folding method.

While the present invention has been particularly described with reference to the example embodiments thereof, the present invention is not limited to the above-described example embodiments. It will be understood by those of ordinary skill in the art that various changes in form and details may be made therein without departing from the spirit and scope of the present invention as defined by the claims.

In addition, although the plurality of operations are described in order in the form of a flowchart, the order of description does not limit the order of executing the plurality of operations. Therefore, when each example embodiment is implemented, the order of the plurality of operations may be changed within a range that does not interfere in content.

Further, it is noted that the inventor's intent is to retain all equivalents of the claimed invention even if the claims are amended during prosecution.

1. A folding method evaluation device comprising:
one or more memories storing instructions; and
one or more processors configured to execute the instructions to:
detect a motion of folding a piece of clothing by a user based on sensor information;
determine correctness of the motion of folding the piece of clothing based on a determination criterion associated to the pieces of clothing; and
output a determination result to an output device.

2. The folding method evaluation device according to claim 1, wherein the sensor information is an image obtained by imaging the motion of folding the piece of clothing by the user, and
the one or more processors configured to execute the instructions to: detect the motion of folding the piece of clothing by the user from the image.

3. The folding method evaluation device according to claim 2, wherein the one or more processors configured to execute the instructions to:
detect a state of the piece of clothing folded by the user from the image, and
further determine whether the state of the piece of clothing is correct, for the motion of folding the piece of clothing.

4. The folding method evaluation device according to claim 1, wherein the one or more processors configured to execute the instructions to:
cause a head-mounted display to display a piece of virtual clothing to be folded by the user in a virtual space, and
detect a motion of folding the piece of virtual clothing by the user based on the sensor information.

5. The folding method evaluation device according to claim 4, wherein the one or more processors configured to execute the instructions to:
change a state of the piece of virtual clothing according to the motion of folding the piece of virtual clothing.

6. The folding method evaluation device according to claim 5, wherein the sensor information is information measured by a sensor worn on a body of the user.

7. The folding method evaluation device according to claim 1, wherein the one or more processors configured to execute the instructions to:
determine the motion of the user based on the determination criterion associated to a situation of folding a piece of clothing.

8. The folding method evaluation device according to claim 7, wherein the one or more processors configured to execute the instructions to:
determine the motion of the user based on the determination criterion associated to the situation by using a surrounding image of the user.

9. The folding method evaluation device according to claim 7, wherein the one or more processors configured to execute the instructions to:
determine the motion of the user based on the determination criterion associated to a situation in which there is a table used when folding a piece of clothing or a situation in which there is no table.

10. The folding method evaluation device according to claim 7, wherein the one or more processors configured to execute the instructions to:
determine the motion of the user based on the determination criterion associated to a situation in which customer handling is performed with a cash register.

11. The folding method evaluation device according to claim 10, wherein the customer handling includes a motion for payment and a conversation with a customer, and
wherein the one or more processors configured to execute the instructions to:
detect the motion for payment and a voice uttered by the user, and
determine correctness of the detected motion and voice.

12. The folding method evaluation device according to claim 1, wherein the one or more processors configured to execute the instructions to:
detect a bagging motion of the user, and
determine correctness of the bagging motion.

13. The folding method evaluation device according to claim 12, wherein the one or more processors configured to execute the instructions to:
determine whether a bag selected by the user in the bagging motion is appropriate for a product to be bagged.

14. The folding method evaluation device according to claim 1, wherein the one or more processors configured to execute the instructions to:
determine correctness of a point where the piece of clothing is held in the motion of folding the piece of clothing.

15. The folding method evaluation device according to claim 1, wherein the one or more processors configured to execute the instructions to:
determine correctness of an order in which the piece of clothing is folded in the motion of folding the piece of clothing.

16. The folding method evaluation device according to claim 1, wherein the one or more processors configured to execute the instructions to:
determine correctness of the motion for each of a plurality of processes of the motion of folding the piece of clothing based on a determination criterion set for each of the plurality of processes.

17. The folding method evaluation device according to claim 1, wherein the one or more processors configured to execute the instructions to:
output, to the output device, information indicating that the motion is incorrect as the determination result.

18. A folding method evaluation method executed by a computer, the folding method evaluation method comprising:
detecting a motion of folding a piece of clothing by a user based on sensor information;
determining correctness of the motion of folding the piece of clothing based on a determination criterion associated to the pieces of clothing; and
outputting a determination result to an output device.

19. A recording medium recording a folding method evaluation program for causing a computer to execute:
processing of detecting a motion of folding a piece of clothing by a user based on sensor information;
processing of determining correctness of the motion of folding the piece of clothing based on a determination criterion associated to the pieces of clothing; and
processing of outputting a determination result to an output device.
